(19) United States
(12) Patent Application Publication
(10) Pub. No.: US 2007/0299728 A1
(43) Pub. Date: Dec. 27, 2007

(54) Interactive Electronic Commerce and Message Interchange System

(76) Inventors: Frank Robert Nemirofsky, Alamo, CA (US); Larry A. Lincoln, Milpitas, CA (US)

Correspondence Address: LAW OFFICE OF MARK J. SPOLYAR, 2200 CESAR CHAVEZ STREET, SUITE 8, SAN FRANCISCO, CA, 94124, US

(21) Appl. No.: 11/850,395

(22) Filed: Sep. 5, 2007

Related U.S. Application Data
(63) Continuation of application No. 10/618,445, filed on Jul. 11, 2003, now abandoned.
(60) Provisional application No. 60/395,579, filed on Jul. 12, 2002.

(51) Int. Cl. G06Q 30/00; G06F 17/30; G06F 17/40

(52) U.S. Cl. 705/14; 379/201.03; 707/104.1

(57) ABSTRACT

Methods, apparatuses and systems enabling an interactive electronic commerce system enabling the targeted exchange of messages with interested users presented with message codes in conventional media, such as television, radio, and printed publications. The present invention allows for the targeted dissemination of information, such as advertising, promotions, sales announcements, coupons, and the like. The present invention, in one embodiment, provides an end-to-end ecommerce solution that transforms the cell phone/PDA (Personal Digital Assistant) into a Universal Digital Assistant which can receive data including advertising, promotions, sales announcement information based on message identifiers encoded into advertising and content from and including the analog and digital TV, TV set-top box, Internet, wireless, radio, satellite and print media. In one embodiment, the present invention enables an interactive electronic coupon system that facilitates the collection and redemption of electronic coupons.

### CROSS-REFERENCE TO RELATED APPLICATION

The present application claims priority from U.S. provisional patent application Ser. No. 60/395,579 filed Jul. 12, 2002 and entitled “Interactive Electronic Commerce and Data Interchange System Featuring Universal Digital Assistant”.

### FIELD OF THE INVENTION

The present invention relates to electronic commerce and, more particularly, to methods, apparatuses and systems facilitating and/or enabling an interactive electronic commerce system, as well as data interchange to various electronic systems featuring universal digital assistant functionality.

### BACKGROUND OF THE INVENTION

Commercial network television has been recognized as a powerful and efficient medium for broadcasting advertising messages to a large, widely disbursed audience. One major drawback of television advertising, however, is network television's ability to do nothing more than deliver advertising messages to a large and relatively undifferentiated audience. Network television, for example, can not by itself provide coupons to, or otherwise interact with, interested viewers.

Traditionally, discounts and other such benefits, e.g. free samples and the like, have been provided or authorized by way of hard copy printing of coupons in newspapers, magazines, mailer brochures and the like. While such printed authorizations, e.g. coupons have been effective and extensively used, they have presented certain problems. Printed coupons require a substantial amount of time to prepare and deliver to the potential user. For example, one may need three months or more to print and deliver such printed coupons. The need for the promotion may change during that time. Moreover, such coupons are largely ignored. by a majority of consumers who are unwilling to take the time to retain the coupon for later use.

In light of the foregoing, a need in the art exists for methods, apparatuses and systems that leverage the ability of television broadcasts to reach large audiences with an interactive system that delivers messages, such as coupons, product offers and the like, to end. users. In one embodiment, the present invention over comes the problems set forth above and permits almost instantaneous delivery of benefit authorizations.

### SUMMARY OF THE INVENTION

The present invention provides methods, apparatuses and systems enabling an interactive electronic commerce system enabling the targeted exchange of messages with interested users presented with message codes in conventional media, such as television, radio, and printed publications. The present invention allows for the targeted dissemination of information, such as advertising, promotions, sales announcements, coupons, and the like. The present invention, in one embodiment, provides an end-to-end ecommerce solution that transforms the cell phone/PDA (Personal Digital Assistant) into a Universal Digital Assistant which can receive data including advertising, promotions, sales announcement information based on message identifiers encoded into advertising and content from and including the analog and digital TV, TV set-top box, Internet, wireless, radio, satellite and print media. In one embodiment, the present invention enables an interactive electronic coupon system that facilitates the collection and redemption of electronic coupons.

### DESCRIPTION OF THE DRAWINGS

FIG. 1 sets forth a computer network environment including an interactive electronic commerce system according to one embodiment of the present invention.

FIG. 2 is a block diagram illustrating the functionality associated with a universal digital assistant according to an embodiment of the present invention.

FIG. 3 shows a message code text message editor interface implemented on a wireless cell phone or other similar device.

FIG. 4 illustrates a display device, such as a screen on a cell phone or PDA, displaying an electronic coupon including a bar code which can be scanned at a point of sale terminal for redemption.

### DESCRIPTION OF PREFERRED EMBODIMENT(S)

### I. Operating Environment

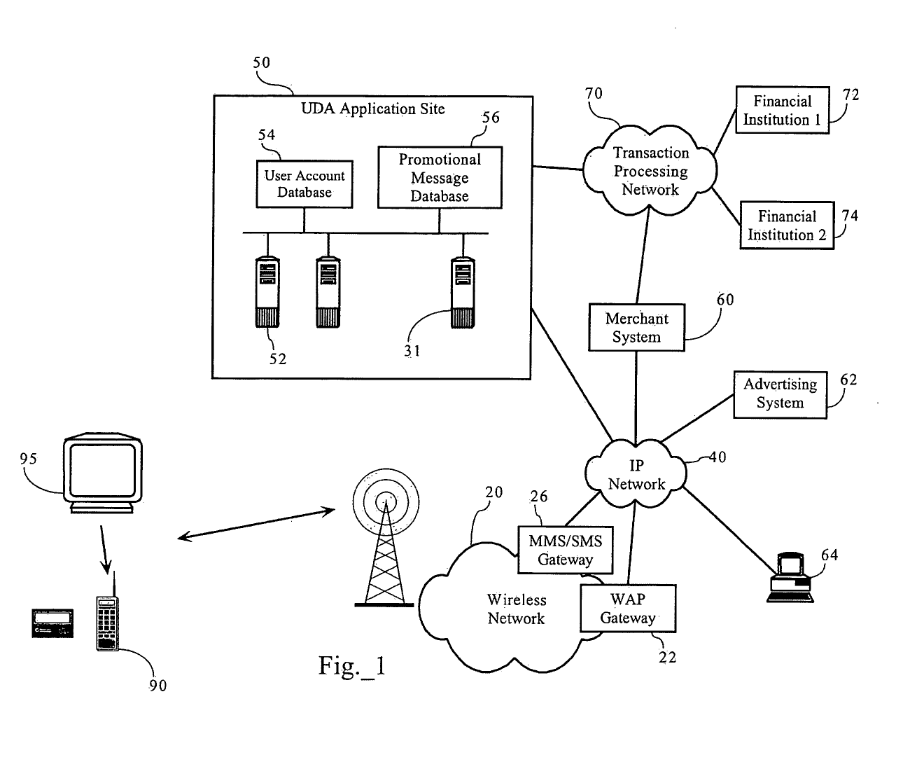

FIG. 1 illustrates an electronic commerce system according to one embodiment of the present invention. As FIG. 1 illustrates, the electronic commerce system operates in connection with a computer network environment including, in one embodiment, a wireless network 20 and IP network 40. Computer network 40 can be any suitable computer network, including an open, wide-area network, such as the Internet. In addition, computer network 40 can comprise an electronic network, an optical network, a wireless network, and/or a combination thereof. In addition, embodiments of the present invention operate in connection with a telecommunications network (e.g., a land-based telephone network, a wireless telephone network, and/or a combination thereof). As FIG. 1 shows, one embodiment of the present invention operates in a computer network environment comprising UDA application site 50, merchant system 60, advertising system 62, at least one network access device, such as client computer 64, at least one transaction processing network 70 (e.g., Automated Clearing House (ACH) Network, credit card network), and at least one financial institution 72, 74, such as a bank.

UDA application site 50 is operably connected to computer network 40 to transmit to and receive data from end systems and other nodes operably connected thereto, such as client computer 64. As FIG. 1 illustrates, the network environment further includes wireless network 20 allowing for transmission of voice and other data to mobile wireless devices, such as universal digital assistant 90. In one embodiment, wireless network 20 comprises WAP gateway 22 and MMS/SMS gateway 26. Computer network 40, in one embodiment, is a packet-based communications environment, employing TCP/IP protocols and has a plurality of interconnected digital packet transmission stations operative to route data between TCP/IP end systems. The present invention, however, has application in computer network environments employing any suitable transport layer and network layer protocols. Client computers 64 are TCP/IP end systems operably connected to computer network 40 via any suitable means, such as through an Internet Services Provider (ISP) and the like. Client computers 64 can be any suitable internet-enabled computing device, such as a desktop computer, a laptop computer, or a cell phone/PDA or UDA having wireless or wireline access to computer network 40 via, for example, a router (e.g., a wireless router executing the 802.11 wireless protocol in connection with a suitable equipped PDA), or via a Mobitex, DataTAC, GPRS, or any other packet-switched wireless network. In one embodiment, client computer 64 includes internet browsing software for receiving, displaying and transmitting data over a computer network.

A. Universal Digital Assistant and UDA Application Site

UDA application site 50 interacts with universal digital assistant 90, as more fully described below, to retrieve messages corresponding to message codes captured in television and print media. In one embodiment, UDA application site 50 exchanges data with universal digital assistant 90, via computer network 40, WAP gateway 22 and wireless network 20, to facilitate financial transactions and other operations enabled by the present invention. UDA application site 50, in one embodiment, comprises at least one application server 52, user account database 54, and advertising and promotional message database 56. Application server 52 includes functionality implementing the process flows described herein. User account database 54 stores information related to at least one user account. Such user account information includes a user account identification, name, address, e-mail address, as well as system settings, preferences, demographic information and behavioral information obtained through monitoring a user's use of the system, as well as privacy-sensitive user applications described herein. User account database 54 further stores financial account information for at least one user to facilitate financial transactions using a universal digital assistant 90. Advertising and promotional message database 56 stores promotional messages, such as advertisements, coupons, and other commercial offers, in association with one or more message codes. In one embodiment, advertising system 62 is operative to transmit promotional messages in electronic form for storage in promotional message database 56 in association with a message code. Application server 52, in one embodiment, is operative to receive a message code from universal digital assistant 90 and return one or more promotional messages associated with the message code, as discussed more fully below. In one embodiment, UDA application site 50 further includes interface server 31 operably connected to a telephone network to, as discussed below, provide a DTMF- or voice-based interface to enable callers to access the message retrieval functionality described herein.

Universal digital assistant 90, in one embodiment, is a wireless device operative to transmit data to and receive data from remote devices over wireless network 20. As discussed in more detail below, in one embodiment, universal digital assistant 90 includes hardware and/or software operative to capture message codes by one to a plurality of code capture technologies and communicate such codes to UDA application site 50. As discussed above, UDA application site 50, in one embodiment, is operative to return at least one promotional message to universal digital assistant 90 for display or other action to the user. The functionality associated with universal digital assistant 90 may be integrated into a variety of wireless device platforms, such as cell phones, wireless personal digital assistants, pagers, and the like. In one embodiment, the functionality of universal digital assistant is incorporated into a television or set-top box remote control unit. In one embodiment, universal digital assistant 90 includes the code capture functionality disclosed in U.S. Pat. No. 5,594,493 and/or U.S. Pat. No. 3,848,082 directed to the capture of codes embedded in television signals including but not limited to NTSC, PAL and Secam. However, as discussed below, universal digital assistant 90 may also include a variety of other code capture technologies in addition to, or in lieu of, the code capture technologies disclosed in the above identified patents.

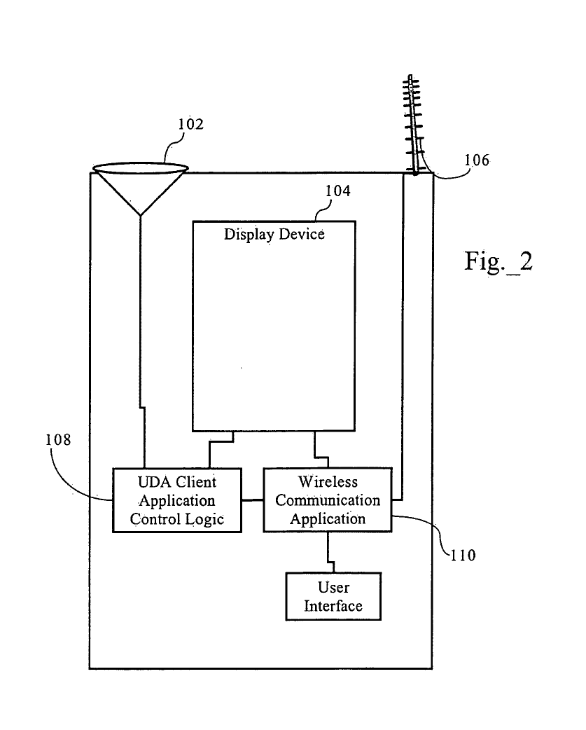

FIG. 2 is a block diagram illustrating the functionality of universal digital assistant according to one embodiment of the present invention. As FIG. 2 illustrates, universal digital assistant 90 includes UDA client application control logic 108, wireless communication interface 110, image capture device 102, display device 104, and antenna 106. UDA client application control logic 108 is operative to execute the client-side functionality described herein, such as capturing message codes and transmitting them via wireless communication interface 110 to UDA application site 50. Wireless communication interface 110 is operative to establish and maintain a connection to wireless network 20 to allow for communication of data between universal digital assistant 90 and remote devices. Display device 104 is a liquid-crystal or other display device. In one embodiment, display device is a touch-sensitive liquid crystal display device. Image capture device 102 is operative to capture message codes transmitted in visual media. Depending on the message encoding technology employed, for example, image capture device 102 may comprise a photo detector and associated. circuitry as disclosed in U.S. Pat. No. 5,594,493. Alternatively, image capture device 102 may comprise a digital camera and image processing functionality allowing for the capture of images containing message codes and the identification of message codes in the captured images. As one skilled in the art will recognize, the functionality described above can be integrated with existing wireless device platforms. For example, UDA application control logic 108 may be implemented by a wireless phone including an embedded runtime environment, such as Java, that executes a script or byte code program that performs the functions described herein and uses the wireless communication facilities of the wireless phone to transmit and receive data from remote devices.

Universal digital assistant 90 may also include additional functionality allowing for other modes of wireless communication over small distances, including infrared (IrDA), Bluetooth, short burst Ethernet, and 802.11 technologies. Such functionality allows universal digital assistant 90, for example, to transmit credit account information directly to a point of sale terminal equipped with complimentary wireless communication functionality.

B. Wireless Network

Wireless network 20 enables communication between universal digital assistant 90 and other systems operably connected thereto. Wireless network 20 can be any suitable digital or analog wireless network, such as a Time Division Multiple Access (TDMA) network, a Global System for Mobile communication (GSM) network, or a Code-Division Multiple Access (CDMA) network. In one embodiment, wireless network 20 includes functionality supporting the Wireless Access Protocol (WAP), a set of communication protocols enabling wireless devices, such as universal digital assistant 90, to access the Internet or similar computer network 40. In one embodiment, wireless network 20 includes WAP gateway 25.

WAP gateway 25 is operative to establish a connection (e.g., a Wireless Session Protocol (WSP) connection) with universal digital assistant 90, receive requests designating an application server or other resource on computer network 40 from universal digital assistant 90, translate the request into an HTTP or other suitable request to the appropriate application server, receive a response from the application server, and translate and transmit the response to universal digital assistant 90. Alternatively, the transmission of data between universal digital assistant 90 and UDA application site 50 can occur over an MMS/SMS gateway 26. In one embodiment, the client functionality of universal digital assistant 90 is operative to configure SMS messages into a predefined format recognized by UDA application site 50. SMS gateway 26 allows nodes connected to computer network 40 to transmit SMS messages to wireless devices within the cell served by that gateway and/or to wireless devices including roaming service capability. For example, MMS/SMS gateway 26 allows universal digital assistant 90 and UDA application site 50 to exchange SMS and/or MMS messages.

Universal digital assistant 90 is operative to receive data from wireless network 20 and transmit data to wireless network 20 for routing to appropriate devices. Universal digital assistant 90, in one embodiment, is an Internet-enabled device capable of receiving data from remote servers and displaying data on a user interface screen. In one embodiment, universal digital assistant 90 is a WAP-enabled device, such as a WAP mobile phone, including a WAP client (e.g., a WAE user agent, such as a WAP browser, and a WTA user agent). In another embodiment, mobile wireless device 50 can be a wireless PDA including HTML-compliant or HTML-supported browser functionality, such as Pocket PC including Pocket Internet Explorer® (PIE), which is a mobile-version of Microsoft's Internet Explorer®, including limited Javascript support and the ability to display HTML and flash files (assuming the Flash plug-in is installed). UDA application site 50 can be configured to support a variety of wireless devices, including IMode phones, and mobile wireless devices including BREW or J2ME technologies.

C. Transaction Processing Networks

Payment transaction processing network 70 supports a variety of non-cash payment mechanisms, such as credit card, debit card, and Automated Clearing House (ACH) transactions. According to one embodiment, the transaction processing networks can be a credit card or debit card transaction processing network, such as VISA®, MASTERCARD®, DISCOVER®, or AMERICAN EXPRESS®. In one embodiment, the transaction processing networks enable users, using universal digital assistant 90, to provide a non-cash method of payment to a merchant system 50 or at a point of sale terminal.

D. Financial Institutions

Banks 72 and 74 are financial institutions at which users maintain. checking and other financial accounts, such as savings accounts, money market accounts, credit and/or debit card accounts, etc. Although, in the illustrative embodiments described herein, one bank corresponds to each user, each user can have a plurality of bank accounts at one to a plurality of financial institutions. For example, a user may have a checking account and a credit and debit account at one financial institution and a credit account with a different financial institution.

E. Client Computer

To facilitate initiation and maintenance of user accounts, users may access UDA application site 50 via network access devices over computer network 40 to manage their respective user accounts. In one embodiment, a network access device is a browser executed on a personal computer 64, or a browser executed on a network computer 64. One embodiment of present invention is implemented using page-based interfaces transmitted to client computer 64 having a browser and a connection to computer network 40. Client computer 64 can be any computer, special-purpose computing device, or any other suitable device for performing the required functionality. In one embodiment, client computer 64 includes at least one processor, a data storage system (including volatile and non-volatile media), a keyboard, a display, at least one input device and at least one output device. In one embodiment, the user's computer is connected to the Internet via a modem dial-up connection or through a network line. Such communication, however, could also be wireless. In addition, although embodiments of the system are described as working in conjunction with a browser, any suitable device or application for receiving, displaying and transmitting data over a computer network can be used in the present invention. In one embodiment, the browser implemented on client computer 64 supports the SSL (“Secure Sockets Layer”) protocol, the S-HTTP (“Secure HTTP”) protocol, or any other similar protocol for transmitting confidential or private information over an open computer network. Users are individuals or other legal entities having the capacity to possess financial accounts, such as corporations, partnerships, non-profit organizations, trusts, and the like.

### II. Operation

As discussed in more detail below, universal digital assistant 90 operates in connection with UDA application site 50 to allow users to receive and review advertising, promotional, informational and other messages, as well as conduct financial transactions and other operations. In one embodiment, the present invention enables an interactive electronic coupon delivery system. According to an embodiment of the present invention, universal digital assistant 90 captures message codes and transmits them to UDA application site 50, which transmits an advertising or promotional message in return. Advertising and promotional messages can take a variety of forms, such as electronic coupons, product pricing and descriptive data, loyalty offerings and the like. According to one embodiment, a user can elect to save the advertising message for possible later use or inspection, either by storing it locally on universal digital assistant 90 or remotely in association with his or her user account maintained by UDA application site 50.

A. Capturing Message Codes with Universal Digital Assistant

As discussed herein, universal digital assistant 90 is operative to detect and/or receive message codes via one to a plurality of code capture technologies. For example, universal digital assistant 90 can be configured to capture codes from televisions or other display devices, print media, or wireless transmissions. In its most basic form, message codes can be captured manually by allowing a user to input a message code directly using the user interface provided by universal digital assistant 90, such as a touch sensitive screen, numeric key pad or voice activated and voice-recognition-based user interface.

A.1. Manual Message Code Capture

In one embodiment, users use the keypad of a cell phone (or other available interface—e.g., a touch sensitive screen, etc.) to enter message codes and transmit them to UDA application site 50, as more fully described below. In the manual case, message codes are preferably alpha-numeric strings made perceptible to users in various media, such as television, print and radio media. For example, during a radio broadcast, a message code may be provided during an advertisement. In print media, the message code may be included on various pages of a magazine or newspaper for example. Communication of captured message codes to UDA application site 50 can be accomplished using circuit-switched (like a normal cell phone call), and packet-switched (similar to a text message) methodologies. The circuit switched option is provided since every cell phone in deployment today supports it. Every form of mass media is supported via keypad entry including message codes appearing on television, Internet, radio and print media.

A.1.a. Circuit-Switched Keypad Interface

The circuit-switched keypad interface option is available to all handset terminals, both analog and digital. The only requirements are that the terminal support in-band DTMF signaling. In this scenario the user simply types in the phone number corresponding to UDA application site 50 and hits the “send” key just as making a normal call. Interface server 31 of UDA application site 50 answers the call and an automatic message prompts the user to enter the message code on the keypad. In this use case, the user hits the “End” key and the transaction is complete. By storing the advertisement processing center's phone number in a quick dial location only the quick dial key needs to be pressed to initiate the call followed by entering the advertisement redemption number on the keypad.

As FIG. 1 illustrates, UDA application site 50, in one embodiment, includes interface server operably connected to telecommunications network 35 to allow users to UDA application site 50 using a voice-based telephone network device, such as POTS telephone or wireless phone 90. Specifically, interface server 31 provides call process flow functionality, prerecorded voice-based scripts, and a voicebased and/or DTMF-based interface allowing users, using touch keys on telephones and/or voice commands, to enter message codes observed in various media. In one embodiment, interface server 31 includes speech recognition functionality operative to translate voice signal data into text data suitable for further processing. A variety of speech recognition systems are known, all of which can be applied to the present invention. Interface server 31 may also be operative to transfer users to customer service call centers upon a request from a user, or the detection of an error or condition requiring human intervention.

A.1.b. Packet-Switched Keypad Interface

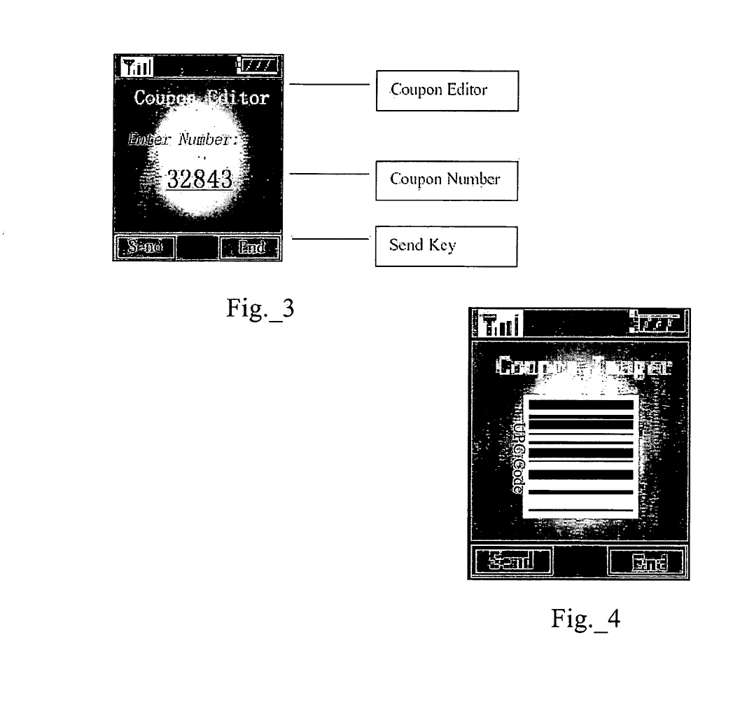

The packet-switched interface option is available to all cell phones that support simple text messaging. Typically all digital phones support simple text messaging. In this scenario the user simply types in the advertisement processing center's phone number for the text message destination and then enters the message code on the keypad into the body of the text message. Pressing the “Send” key automatically sends the text message to UDA application site 50. Utilizing text messaging also allows UDA application site 50, in one embodiment, to push the promotional message corresponding to the message code back to the user's phone. A FIG. 3 illustrates, with customization of the text message editor software in the phone, a custom “message code text message editor” can be created which already knows the advertisement processing center's phone number. In such as embodiment, the user need only enter the message code and hit “send”.

A.1.c. Voice Recognition Interface

In one embodiment, message code entry takes advantage of voice recognition technology already heavily deployed in cell phone handset terminals today. One such embodiment leverages the same customized “message code text message editor” described above with voice recognition technology to allow users to enter the message code using simple voice commands. Additionally, users can access the “message code text message editor” by simply saying the key work “message code” instead of navigating the menu system of the cell phone or other device. In this case the user only says one word “message code” to invoke the message code text message editor, speak the message code and the word “send” to transmit the text message to UDA application site 50.

A.2. Video/Television Signals

In one embodiment, universal digital assistant 90 is operative to capture message codes embedded or otherwise transmitted in connection with a television signal and displayed on a display device 95, such as a television or computer monitor. For example, universal digital assistant 90 may include the code capture technologies whereby a user, using universal digital assistant 90, aims the device at a television or computer display and captures an image of the television or other video display. The captured image or a portion thereof is then processed to locate a message code and translate the message code to yield a message code identification. In one embodiment, universal digital assistant 90 includes digital camera technology to capture an image and image processing functionality to locate and identify a message code, if any, in the captured image. In one embodiment, message codes may be displayed on the television or other display as plain text codes at a predetermined location on the display. In such an embodiment, the image processing functionality of the universal digital assistant 90 is operative to locate the message code and use text recognition functionality to identify the message code. In another embodiment, message codes are displayed as graphical symbols which the universal digital assistant processes to identify message codes. In one embodiment, universal digital assistant emits a beam of light (e.g., Class II Laser Pointer 635 nm<1.0 mW safe per FDA assuming 0.25 second blink reflex) that helps the user to aim the image capture device at the television or video display. In one embodiment, universal digital assistant 90 captures the image from a television or computer display and transmits it to a remote processor, such as UDA application site 50, for analysis and resolution of a message code. In one such embodiment, the captured image is transmitted to UDA application site as an MMS message. In another embodiment, the incoming message code can be embedded in the audio track of the television signal. The embedded message code can be subliminal (not perceptible to the user) or overt.

According to one embodiment of the present invention, the message codes are presented as overt checkerboard-like designs which are captured with a digital camera. In one embodiment, the digital camera is integrated into the UDA, such as digital cameras embedded in cell phones. Some features of the checkerboard are fixed to allow easy alignment to the data transfer part of the image. The left column is all black. The next two columns work as a pair in some cases, such as at the top and bottom where they are all black. At multiple other places in this pair of columns, 4 blocks (where the top two are white and the bottom two are black) work to define a set of white to black transitions while scanning down the image. The black edge and the transitions are picked out of the larger image. Between subsequent transition blocks, data is passed in one row of bits, black or white or both. Other images are contemplated to allow data transfer of the relatively small quantity of bits needed to identify information including the television broadcaster or the content being broadcast. Of course, any suitable graphical technique to express message codes can be used.

In another embodiment, the present invention may incorporate the code capture technologies disclosed in U.S. Pat. No. 5,594,493 incorporated by reference herein, which teaches methods and apparatuses that capture embedded codes expressed in modulated luminance levels in a television signal. In addition, universal digital assistant may employ the code capture technologies disclosed in U.S. Pat. Nos. 3,848,082, 4,807,031 and 5,633,766, incorporated by reference herein, which teach the encoding of data in the effective viewing area of a video signal.

In one embodiment, the message code can be an arbitrary alphanumeric string that is associated with an advertising or promotional message. In another embodiment, the message code can identify the television station to which the television is tuned (such as station call letters, station ID, etc.). In such an embodiment, an advertisement or promotional message can be identified by reference to the station ID and the time the message code was captured. In one embodiment, scanning this information against a station log, UDA application site 50 can resolve the advertising or other content the user was watching and return an advertising or promotional message associated with the broadcast advertising or other content.

In another embodiment, universal digital assistant 90 operates in connection with a television set-top box to receive message codes. According to one embodiment, the digital set-top box is configured to receive message codes transmitted using any suitable means. Universal digital assistant 90 can then receive the message codes from the digital set-top box via wireless transmission, such as Bluetooth, 802.11b, and Wi-Fi. This embodiment bypasses the need for over the screen message code transmission. In one embodiment, at the time a broadcast displays an offer of interest, user action will trigger UDA 90 to contact the set-top box. The set-top box responds with the message code and/or details of the offer. UDA 90 can then transmit the code as described above. Alternatively, the set-top box may pass the query to UDA application site 50, eliminating the need for a wide area network connection between the universal digital assistant 90 and UDA application site 50.

A.3. Print Media

In one embodiment, universal digital assistant 90 is operative to capture message codes from print media and the like. In one embodiment, universal digital assistant 90 includes a digital camera and image processing functionality that is operative to extract at least one message code from a captured image of a print advertisement. In another embodiment, universal digital assistant 90 includes bar code scanning functionality operative to read a bar code expressing a message code in the print media.

A.4. Wireless Transmissions

As discussed above, universal digital assistant may be configured to receive message codes transmitted by devices within the immediate vicinity of the universal digital assistant. For example, universal digital assistant may receive message codes from a transponder transmitting message codes using technology including infrared, Bluetooth, IEEE 802.11, Wi-Fi, or short burst Ethernet technologies. Such transponders may be located at a variety of physical locations, such as a point of sale location, a movie theater, a mall, or a restaurant.

B. Retrieving Electronic Commerce and Data Interchange Messages

As discussed above, after a message code is captured, the universal digital assistant 90 is configured to transmit the message code to UDA application site 50 which resolves the message code and returns an electronic commerce and/or data interchange message. In one embodiment, application server 52 receives a request including the message code and accesses advertising message database 56 to retrieve at least one message associated with the message code. If a message is found, application server 52 transmits it to universal digital assistant 90, and/or stores the message in association with the user's account for subsequent access. Application server 52 can also perform other functions, such as logging the message code and/or advertising message in association with the user's account. Application server 52 may also log the message code to track usage of the system to allow for implementation of a fee-based service. For example, an advertiser may be charged a fee for each promotional message transmitted to a universal digital assistant. In addition, UDA application site 50, in one embodiment, is configured to transmit usage/activity reports to advertising system 62 detailing the activity associated with promotional messages.

The message transmitted by UDA application site 50 may take many forms. For example, the message may be transmitted as an email to a user's email account. Alternatively, the message may be transmitted as an SMS message to the user's cell phone. In one embodiment, the message may be transmitted using the Multimedia Messaging Service (MMS) to transmit a digital image of a coupon for example including a UPC code expressed as a bar code (see FIG. 4). This coupon, in one embodiment, can be redeemed by a user by displaying the coupon on a display 104 of universal digital assistant 90 and having a bar code scanner at a point of sale terminal pass over the display 104. As one skilled in the art will recognize, this embodiment allows users to gather coupons and redeem them without having to collect and retain physical coupon slips and the like. In addition, since the electronic coupons are contained in the user's cell phone, for example, the user is more apt to use the coupons and purchase the promoted product or service.

As discussed above, a user may perform a variety of actions with respect to the promotional message. The user may view the promotional message and simply discard it. Alternatively, the user may save the promotional message by storing it locally, or remotely in association with the user's account maintained by UDA application site 50. For example, the promotional message may be an electronic coupon, which the user may store for later redemption at a point of sale location or by accessing merchant system 50 using client computer 64, or directly at a point of sale location using universal digital assistant 90.

In one embodiment, universal digital assistant 90 allows the user to manage electronic coupons received by the user. In one embodiment, navigation through existing coupons will be facilitated by standard PDA user interface capabilities: 1) scan categories then select one to view, scan coupons in the category; 2) delete a coupon or mark it for a special. category: shopping list; 3) view list of coupons to expire in 2 weeks; 4) At a point of sale location, provide easy IrDA access to list of UPC codes for stored coupons. In one embodiment, once a coupon has been redeemed, it is marked for deletion. Coupons noted to have past their “good thru” date are also marked for deletion. In one embodiment, universal digital assistant 90 requires the user to explicitly invoke the batch deletion. In another embodiment, universal digital assistant 90 automatically performs such batch deletions.

C. Conducting Financial Transactions

As discussed above, universal digital assistant 90 may also be configured to facilitate financial transactions. For example, and in one embodiment, universal digital assistant 90 may securely store a user's financial account information, such as credit or debit card account numbers, checking account identifications and the like. Using a wireless transmission protocol, such as IrDa or Bluetooth, universal digital assistant 90 can transmit account information directly to a transaction processing device at a point of sale location. The transaction processing device can authorize or otherwise process the transaction in a conventional manner. In one embodiment, UDA application site 50 can be involved in such point of sale transactions. For example, universal digital assistant 90 may transmit information related to the point of sale transaction to be logged in a financial transaction history maintained in association with the user's account. In addition, UDA application site 50 may be invoked to transmit a previously stored electronic coupon to universal digital assistant 90 to allow the user to redeem it at the point of sale location.

In another embodiment, the user's financial account information may be maintained at UDA application site 50. In one form, a transaction at a point of sale location can be completed where the user activates universal digital assistant 90 to request the user account information from UDA application site 50. After it receives the user account information, universal digital assistant 90 transmits the account information to the transaction processing device as described above.

Furthermore, universal digital assistant 90, as a WAP-enabled device for example, can be used to conduct transactions with merchant system 50 over computer network 40. For example, universal digital assistant 90 may be configured to include electronic wallet functionality (operating independently or in connection with UDA application site 50) operative to facilitate on-line financial transactions with merchant system 50 over computer network 40.

Lastly, the present invention has been described with reference to specific embodiments. Other embodiments of the present invention will be apparent to one of ordinary skill in the art. It is, therefore, intended that the scope of the invention not be limited to the embodiments described above.

1. An electronic commerce system facilitating interactive message exchange, comprising
a message database storing at least one messages in association with one or more message codes;
an application server operative to
receive a message code,
retrieve from the message database one or more messages associated with the message code;
an interface server operative to
interact with a remote device to receive a message code, wherein the message code was embodied as a graphical representation in an image presented on a display device, and wherein at least a portion of the image including the graphical representation was captured by the remote device,
provide the message code to the application server for retrieval of at least one message,
transmit the at least one message to the remote device.

2. The system of claim 1 wherein the at least one message in the message database is an electronic coupon.

3. The system of claim 1 wherein the al least one message is the message database is a promotional message.

4. The system of claim 1 wherein the message code further identifies a source of the message code.

5-7. (canceled)

8. The system of claim 1 wherein the interface server is operatively connected to a telephone network and further comprises call process flow functionality operative to prompt users for message codes, and a DTMF interface operative to receive DTMF signals and resolve the DTMF signals into message codes.

9. The system of claim 1 wherein the interface server is operative to receive text messages including message codes from the remote device and provide the at least one retrieved message to the remote device in a text message.

10. The system of claim 9 wherein the text message is an SMS message.

11. The system of claim 1 wherein the message code transmitted from the remote device is embodied in a digital image, and wherein the application server is operative to process the digital image to identify the message code.

12. The system of claim 11 wherein the digital image containing the message code is embodied in an MMS message transmitted by the remote device.

13. A method of using a wireless device to receive product information, comprising
capturing a graphical representation of a message code appearing on a display device,
transmitting the message code to a remote system,
receiving, from the remote system, a coupon message corresponding to the message code,
providing the coupon message to a point-of-sale terminal.

14. The method of claim 13 further comprising displaying the coupon message on a display device, the coupon message, when displayed, including indicia resolvable by an optical device associated with the point of sale terminal wherein the indicia are bar codes.

15. The method of claim 14 wherein the indicia are bar codes.

16. The method of claim 13 wherein the coupon message is embodied in an MMS message.

17. An interactive electronic coupon system, comprising
a coupon message database storing at least one coupon message in association with one or more message codes; wherein the at least one coupon message comprises a digital image of a coupon bar code,
an application server operative to
receive a message code,
retrieve from the message database one or more coupon messages associated with the message code;
an interface server operative to
interact with a remote device over a computer network to receive a message code, wherein the message code was embodied as a graphical representation in an image presented on a display device, and wherein at least a portion of the image including the graphical representation was captured by the remote device,
provide the message code to the application server for retrieval of at least one message,
transmit one or more coupon messages corresponding to the message code to the remote device.

18. The system of claim 17 wherein the message code further identifies a source of the message code.

19. The system of claim 18 wherein the source is a television station.

20. The system of claim 17 wherein the remote device processed the captured graphical representation to resolve the message code.

21. The system of claim 17 wherein the message code transmitted from the remote device is embodied in a digital image, and wherein the application server is operative to process the digital image to identify the message code.

22. The system of claim 21 wherein the digital image containing the message code is embodied in an MMS message transmitted by the remote device.

23. The system of claim 17 wherein the coupon message is embodied in an MMS message.
